(19) United States
(12) Patent Application Publication
(10) Pub. No.: US 2026/0047521 A1
(43) Pub. Date: Feb. 19, 2026

(54) AGRICULTURAL MACHINE WITH DRIVER ASSISTANCE SYSTEM

(71) Applicant: CLAAS Selbstfahrende Erntemaschinen GmbH, Harsewinkel (DE)

(72) Inventors: Tarek Kösters, Köln (DE); Andreas Wilken, Bissendorf (DE); Bastian Bormann, Gütersloh (DE); Matthias Domnik, Oelde (DE); Waldemar Thiesmann, Osnabrück (DE); Henner Vöcking, Rietberg (DE); Oliver Nelles, Netphen-Herzhausen (DE)

(73) Assignee: CLAAS Selbstfahrende Erntemaschinen GmbH, Harsewinkel (DE)

(21) Appl. No.: 19/298,451

(22) Filed: Aug. 13, 2025

(30) Foreign Application Priority Data
Aug. 13, 2024 (DE) 10 2024 123 032.0

(51) Int. Cl. A01D 41/14; A01D 41/127

(52) U.S. Cl. CPC A01D 41/141; A01D 41/1271; A01D 41/1277

(57) ABSTRACT

An agricultural work machine comprising a driver assistance system. The driver assistance system is configured to automatically optimize and adjust work parameters and quality parameters of the agricultural work machine. The driver assistance system is assigned a process model comprising characteristic maps such that an optimization method implemented by the driver assistance system comprises a characteristic map control generating optimized work parameters as a control variable. The driver assistance system determines the quality parameters of the agricultural work machine depending on the optimized work parameters. The process model comprises a basic process model and an affine output layer assigned thereto, forming submodels. The basic process model is configured to map relationships between a plurality of process parameters in the characteristic maps for generating an optimized quality parameter, and the affine output layer is configured to define the particular quality parameter depending on two process parameters.

### CROSS REFERENCE TO RELATED APPLICATION

This application claims priority under 35 U.S.C. § 119 to German Patent Application No. DE 10 2024 123 032.0 filed Aug. 13, 2024, the entire disclosure of which is hereby incorporated by reference herein.

### TECHNICAL FIELD

The present invention relates to an agricultural work machine comprising a driver assistance system.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Driver assistance systems may optimize the operation of agricultural work machines, such as harvesting machines, and thereby may largely relieve the operator of the agricultural work machines of monitoring and adjustment tasks. For example, US Patent Application Publication No. 2012/0004813 A1, incorporated by reference herein in its entirety, discloses a driver assistance system that determines optimized setting parameters of the working units of an agricultural harvester based on a characteristic map.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an example schematic view of the agricultural work machine with the driver assistance system.

FIG. 2 illustrates one example of details of the process model-based optimization of work parameters of the agricultural work machine.

FIG. 3 illustrates another example of details of the process model-based optimization of work parameters of the agricultural work machine.

### DETAILED DESCRIPTION

As discussed in the background, driver assistance systems may optimize the operation of agricultural work machines. In one or some embodiments, the optimization process may comprise determining the optimized work parameters in an iterative process. Such systems may be well suited to quickly determine optimized work parameters of the harvesting machine under more or less homogeneous harvesting conditions. In the case of rapidly changing harvesting conditions, such methods may have the disadvantage that, due to the inertia of the optimization method, a certain adjustment process must be run through until the harvester is again working at an optimized operating point.

The quality of the employed characteristic map (interchangeably termed a performance map) may have a significant influence on the particular optimization result. For example, US Patent Application Publication No. 2014/0019017 A1, incorporated by reference herein in its entirety, discloses that certain operating points of the characteristic map lying outside the current operating range may be specifically approached in order to keep the characteristic map updated over a wide range of the overall characteristic map. This may have the effect that the mathematical relationships that determine the characteristic map is adapted in such a way that the determination of optimized work parameters is accelerated. The disadvantage of such methods, however, is the additional effort for the targeted control of operating points not lying in the current operating field.

In order to enable a characteristic map used to optimize the work parameters of an agricultural work machine, such as a combine harvester, to quickly determine optimized work parameters, US Patent Application Publication No. 2023/0099523 A1, incorporated by reference herein in its entirety, discloses assigning to a characteristic map a so-called control characteristic, which may summarize the particular optimal working points over a large range of the characteristic map, and for the assistance system to control the parameter optimization process along this optimal characteristic. This may have the advantage that the optimum operating points are reached more quickly using this characteristic map-based optimization. However, a disadvantage may be that abrupt changes in the harvesting conditions are reacted to with a residual inertia since the optimization system must first control the new optimum operating point aligned with the control characteristic.

Furthermore, US Patent Application Publication No. 2025/0057079 A1, incorporated by reference herein in its entirety, discloses an optimization method that may quickly adapt the optimization of operating parameters to changing process conditions, such as abruptly changing harvesting conditions. To achieve this, US Patent Application Publication No. 2025/0057079 A1 discloses that the saved process model be designed as a dynamic nonlinear process model that may comprise a static process model component and a dynamic process model component so that the characteristic map control may, on the one hand, react quickly (e.g., dynamically) to changing process conditions and, on the other hand, the process model itself may be gradually adapted to these dynamic changes in the process conditions. Such a system may be very well suited to react quickly to dynamic changes in process conditions. A disadvantage of such a method is that the entire saved characteristic map may always be updated, which may lead to long so-called holding times until the adaptation of the process model is complete. In addition, such methods may not recognize repetitive similar process behavior.

Thus, in one or some embodiments, a driver assistance system is disclosed which is configured to adapt quickly to the real harvesting conditions, such as reacting quickly to abrupt changes in the harvesting conditions and recognizing repetitive similar process behavior.

In one or some embodiments, an agricultural work machine is disclosed with a driver assistance system configured to automatically optimize and adjust one or both of working parameter(s) or quality parameter(s) of the agricultural work machine. The driver assistance system may be assigned a process model comprising one or more characteristic maps so that an optimization method, to be implemented by the driver assistance system, is designed as a characteristic map control. The optimization method may generate optimized work parameters as control variables, and the driver assistance system may determine the quality parameters of the agricultural work machine depending on the optimized working parameters. The process model may comprise a basic process model and an affine output layer assigned thereto. The basic process model and the affine output layer may form submodels of the process model, with the basic process model being configured, designed or indicative of characteristic map relationships between a large number of process parameters in the characteristic maps for the generation of an optimized quality parameter. Further, the affine output layer may be configured to define the respective quality parameter depending on one or more process parameters, such as at least two process parameters. In one or some embodiments, affine may comprise a transformation, such as a transformation of coordinates, that may be equivalent to a linear transformation followed by a translation. In this way, the driver assistance system may adapt quickly to the actual harvesting conditions and, in particular, may react quickly to abrupt changes in the harvesting conditions.

With a small number of available data points, it may be difficult to adapt the basic process model robustly so that it may take a long time before the basic process model may describe the process (e.g., the mode of operation of the agricultural work machine) under the current conditions. The affine output layer may make it possible to robustly adapt the process model even with a small number of available data points. The affine output layer may therefore make it possible for the process model to describe the process more quickly so that better optimization results may be achieved even with few available data points. If sufficient data points are available, as is typically the case in the ongoing harvesting process, a process model may then be used for optimization, which may process significantly more data points, such as the basic process model, and ultimately may achieve better optimization results due to the more complex relationships being taken into account.

In one or some embodiments, the basic process model and the affine output layer may be activated or executed independently of each other, with activation or execution causing an adjustment of the performance maps saved in the particular submodel so that a high-quality optimization of the operation of the agricultural work machine may be achieved in a targeted manner depending on the available data points/information.

In one or some embodiments, the adaptation of the process model and its submodels may comprise adaptation phases, wherein the respective adaptation phase may be adapted depending on the available process information. In this way, it may be ensured that the assistance system may select a suitable process model for optimizing the operation of the agricultural work machine depending on the available process information.

In this context, it may be advantageous if a first adaptation phase is designed and configured as an initialization phase, wherein in the initialization phase, the adaptation of the process model may be limited to the adaptation of the submodel with the affine output layer so that, for example, when driving into a crop stand with the little available process information, a sufficiently good optimization result is achieved. In one or some embodiments, a second adaptation phase may be designed and configured as a respective adaptation phase, wherein in this respective adaptation phase, the adaptation of the process model is limited to the adaptation of the basic process model (as opposed to adaptation of the submodel with the affine output layer) so that when a larger amount of process information is available, a more complex adaptation method may be selected, which may achieve improved optimization results. In this context, it may also be advantageous that a third adaptation phase is designed and configured as an optimal phase, wherein in the optimal phase, the adaptation of the process model is limited to the adaptation of the basic process model, wherein the parameterization of the adaptation method in the optimal phase differs from the parameterization of the adaptation method in the respective adaptation phase, and wherein the parameterization comprises the adaptation speed and the regularization strength. This may have the effect that, in a more homogeneously transpiring process such as in a harvesting process with a homogeneous crop structure and a settled characteristic map, a process model capturing complex relationships may be accessed. Further, the adaptation of this complex process model may be less extensive due to the more homogeneous conditions. Consequently, in the optimal phase, the adaptation speed may be lower and the regulation strength may be less in comparison to the respective adaptation phase. In this regard, the respective phases may be different and tailored to the process and/or the information available.

In one or some embodiments, the process information may be formed by any one, any combination, or all of the quantity of available data points, the available environmental parameters and the adaptation state (which is determined by the data availability), the excitation of the process by the work parameters, the convergence behavior of the adaptation method, and/or the variance of the estimation of certain process parameters in the submodel of the process basic model. The driver assistance system may switch, such as automatically switch, between the respective adaptation phases depending on this process information. In this regard, in one or some embodiments, the driver assistance system may automatically analyze the process information, and responsive to the analysis, automatically switch between the respective adaptation phases. In this way, extensive process information may be taken into account, which may ensure a high-quality optimization process.

In this context, in one or some embodiments, the driver assistance system may start or begin its processing in the initialization phase at the beginning of harvesting and may automatically switch to the adaptation phase depending on any one, any combination, or all of: the amount of available data points, the available environmental parameters, and the adaptation status, which together may form the process information. In turn, based on the driver assistance system's analysis of the process information, the driver assistance system may automatically switch to the optimal phase upon reaching a quasi-stationary phase of the basic process model. In this manner, it may be ensured that, depending on the available process information, the adaptation phase that delivers the best possible model and therefore ultimately the best possible optimization result may be selected, such as always selected. In that the driver assistance system may automatically determine the respective adaptation state as described above (e.g., based on the data availability and/or the excitation of the process by the work parameters and/or the convergence behavior of the adaptation method and/or the variance of the estimation of certain process parameters in the submodel of the basic process model), it may also be ensured that the process model depicts the process sufficiently accurately to achieve a high-quality optimization process.

In one or some embodiments, the complex interrelationships that may play a role in optimizing the operation of an agricultural work machine may be achieved when the basic process model represents a nonlinear, dynamic process behavior.

In order to achieve a sufficiently good optimization result for the operation of the agricultural work machine even when less process information is available, the submodel with an affine output layer may map a linear process behavior in such a way that the particular performance map is any one, any combination, or all of stretched, compressed, or shifted in space.

In one or some embodiments, the operation of the agricultural work machine uses one or more quality parameters, including any one, any combination, or all of: “threshing loss,” “broken grain content,” “separation loss,” “cleaning loss,” “threshing unit load,” “fuel consumption,” “returns grain fraction,” or “returns volume.”

In one or some embodiments, an efficient and high-quality optimization process may be ensured when the one or more process parameters include any one, any combination, or all of: work parameters of the agricultural work machine; environmental parameters; or harvested material parameters. In this context, in one or some embodiments, the work parameters of the agricultural work machine may include, for example, any one, any combination, or all of the threshing drum rotational speed, the concave width, the driving speed, the rotational speeds of the threshing and separating rotors, the position of the so-called closing flaps (if the threshing and separating rotors have such flaps), the fan rotational speed, and/or the so-called top and bottom sieve widths. In one or some embodiments, the work parameters of the agricultural work machine may be the harvested material parameters of any one, any combination, or all of throughput, straw moisture, and/or grain moisture.

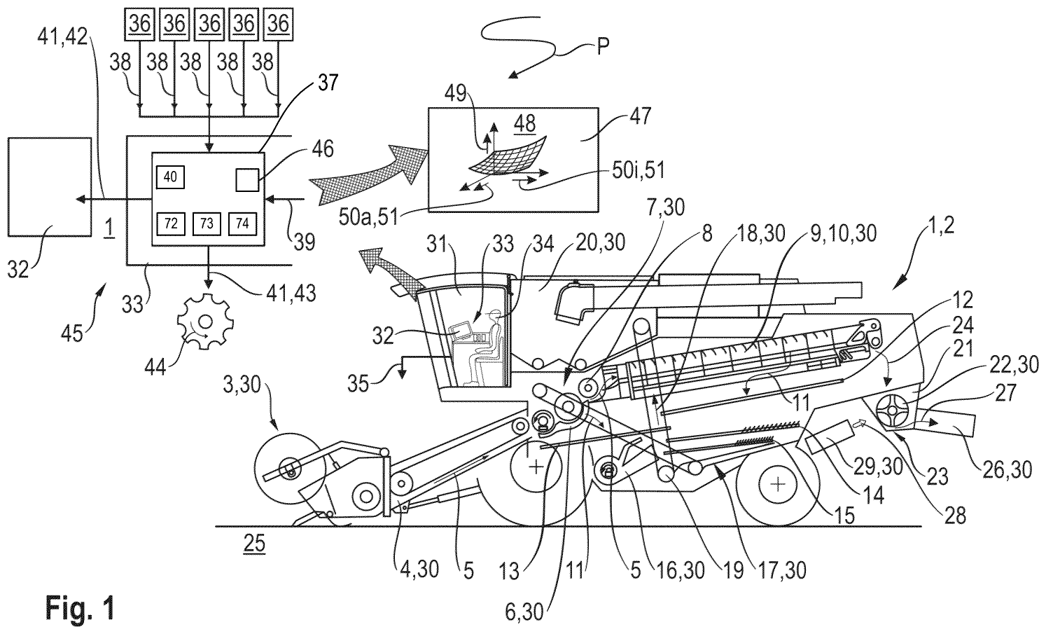

Referring to the figures, FIG. 1 illustrates an agricultural work machine 1, which may comprise a combine 2, and which may have attached thereto a grain header 3 in its front region (connected in a known manner to the inclined conveyor 4 of the combine 2). The flow of harvested material 5 passing through the inclined conveyor 4 may be transferred in the upper rear region of the inclined conveyor 4 to the threshing units 7 of the combine 2, which may be at least partially surrounded by a so-called threshing concave 6 on the bottom. A diverter roller 8 downstream from the threshing units 7 may divert the material flow 5 out of the threshing units 7 in their rearward area so that the flow is transferred, such as immediately transferred, to a separating device 10 designed as a separating rotor assembly 9. In one or some embodiments, the separating device 10 may also be designed as a straw walker. In one or some embodiments, the separating device may be designed with a single rotor or two rotors, or the threshing units 7 and the separating device 10 may be combined to form a single-or double-rotor axial flow threshing and separating device. In the separating device 10, the flow of harvested material 5 may be conveyed in such a way that free-moving grains 11 contained in the material flow 5 are separated in the downstream region of the separating device 10. The grains 11 deposited both on the threshing concave 6 and in the separating device 10 may be fed over a returns pan 12 and a feed pan 13 of a cleaning device 17 comprising (or consisting of) a plurality of screening levels 14, 15 and a fan 16. The cleaned flow of grains 18 may then be transferred using elevators 19 to a grain tank 20.

In the rear region of the separating device 10, a shredding device 23, designed as a straw chopper 22 and surrounded by a funnel-shaped housing 21, may be associated with the separating device 10 in the depicted embodiment. The straw 24 leaving the separating device 10 in the rear region may be fed to the straw chopper 22 at the top. In a manner not shown, the straw 24 may also be diverted after the separating device 10 so that it is deposited directly on the ground 25 in a swath. In the outlet area of the straw chopper 22, the material flow, comprising (or consisting of) the chopped straw 24 and the non-grain components separated in the cleaning device 17, may be transferred to a crop distribution device 26, which may discharge the residual material flow 27 in such a way that a wide distribution of the residual material flow 27 occurs on the ground 25. In the depicted embodiment, the residual material flow 28 separated in the cleaning device 17 is discharged into the straw chopper 22 via a so-called chaff spreader 29, where it may ultimately be conveyed out of the combine harvester 2 as a common residual material flow 27 using the crop distribution device 26. Various working units within agricultural work machine 1 are contemplated. For example, any one, any combination, or all of the grain header 3, the inclined conveyor 4, the threshing units 7 and the threshing concave 6 assigned thereto, the separating device 10, the cleaning device 17, the elevators 19, the grain tank 20, the straw chopper 22, the crop distribution device 26 and the chaff spreader 29 may comprise working units 30 of the agricultural work machine 1.

Furthermore, the agricultural work machine 1 may have a vehicle cabin 31 in which is arranged at least one control and regulating device 33 provided with a display unit 32 (e.g., a touchscreen), through which a plurality of processes P, which are described below in more detail, may be controlled automatically or initiated by the operator 34 of the agricultural work machine 1. The control and regulation device 33 may communicate (e.g., wired and/or wirelessly) with a plurality of sensor systems 36 via a so-called bus system 35 in a manner known per se. Details relating to the structure of the sensor systems 36 are described in detail in US Patent Application Publication No. 2003/0066277 A1, the entire contents of which are hereby incorporated by reference herein.

Furthermore, FIG. 1 shows a schematic representation of the display unit 32 of the control and regulating device 33 and the computing unit 37 associated with the control and regulating device 33 and coupled to the display unit 32. The computing unit 37 may be configured to automatically process any one, any combination, or all of information 38 generated by the sensor systems 36, external information 39, and/or information 40 saved in the computing unit 37 itself, such as expert knowledge, with the computing unit 37, based on the automatic processing, automatically generating a plurality of output signals 41, which may comprise commands and/or control signals. For example, the output signals 41 may comprise at least display control signals 42 and working unit control signals 43, wherein the former determines the contents of the display unit 32 and the latter automatically causes the change in the various work parameters 44 of the working units 30 of the agricultural work machine 1 (which in turn modifies operation of the respective working units 30), wherein the arrow 44 symbolically represents the threshing drum rotational speed. The control and regulating device 33 with the display unit 32 associated therewith and the computing unit 37 may be part of the driver assistance system 45, which will be described in more detail.

In one or some embodiments, the computing unit 37 may comprise at least one processor 72 and at least one memory 73 (configured to store data, such as information 38 generated by the sensor systems 36, external information 39, information 40 saved in the computing unit 37, characteristic maps, process model(s) (e.g., process model 47 including basic process model 58 and an affine output layer 59), software, executable code, or the like). The computing unit 37 may further include at least one communication interface 74 (configured to communication with devices external to the computing unit 37, such as working units 30, other electronic devices, or the like). The at least one processor 72 and at least one memory 73 may be in communication (e.g., wired and/or wirelessly) with one another. In one or some embodiments, the processor 72 may comprise a microprocessor, controller, PLA, or the like. Similarly, the memory 73 may comprise any type of storage device (e.g., any type of memory, such as RAM, ROM, or a combination thereof). Though the processor 72 and the memory 73 are depicted as separate elements, they may be part of a single machine, which includes a microprocessor (or other type of controller) and a memory. Alternatively, the processor 72 may rely on the memory 73 for all of its memory needs. Still alternatively, the processor 72 may rely on a database for some or all of its memory needs. The memory 73 may comprise a tangible computer-readable medium that include software that, when executed by the processor 72 is configured to perform any one, any combination, or all of the functionality described herein. Further, the communication interface 74 may be configured to communicate (e.g., wired and/or wirelessly) with one or more electronic devices.

The processor 72 and the memory 73 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, a process optimization module 46 is associated with the driver assistance system 45, wherein the process optimization module 46 may be a component of the computing unit 37. One or more process models 47 may be associated with the process optimization module 46, which may describe the processes P that occur in the agricultural work machine 1, which is described in more detail below. The one or more process models 47 may comprise or be described by characteristic maps 48, whereby the relationship between quality parameters 49 and work parameters 50a . . . i of the agricultural work machine 1 may be defined in each respective characteristic map 48.

The processes P described by the respective process model 47 may be, for example, the threshing process, the separation process or the cleaning process of the harvested material 5, to name just a few processes P by way of example. The quality parameters 49, 49a may be, for example, the quality parameters of any one, any combination, or all of “threshing loss”, “broken grain fraction”, “separation loss”, “cleaning loss”, “threshing unit load” and “fuel consumption”, “returns grain fraction” and “returns volume”, which are known per se and are therefore not described in more detail here. The work parameters 50a . . . i of the agricultural work machine comprise, on the one hand, parameters relating to the harvested material flow 5 such as any one, any combination, or all of the harvested material throughput, the layer height of the harvested material flow 5 detected in the agricultural work machine and/or the moisture of the harvested material flow 5. On the other hand, the work parameters 50a . . . i may comprise parameters relating to the working units 30 of the agricultural work machine, such as the already-mentioned threshing drum rotational speed 44 and/or the rotational speed of the fan 16 associated with the cleaning device 17, to mention just two here only by way of example. The example shown in FIG. 1 for a characteristic map 48 describing a process model 47 could, for example, describe the quality parameter 49 of “separation loss” depending on the work parameters of threshing drum rotational speed 44, 50a and the layer height 50i related to the harvested material flow 5.

As discussed above, the agricultural work machine 1 (which may comprise a combine harvester 2) may include the driver assistance system 45, which may be configured to automatically monitor and automatically set the work parameters 44, 50a . . . i and/or the quality parameters 49 of the combine harvester 2. In this regard, the driver assistance system 45 may support the operator 34 of the combine harvester 2 in the operation of the combine harvester 2. This may initially be possible because the driver assistance system 45 is assigned a process model 47 comprising a characteristic map 48, with the process model 47 defining the particular quality parameter 49 depending on manipulated variables 51, such as the work parameters 50a . . . i, and the driver assistance system 50 may be configured to automatically determine optimized work parameters 50a . . . i of the agricultural working machine 1 depending on the particular process model 47, as described further below.

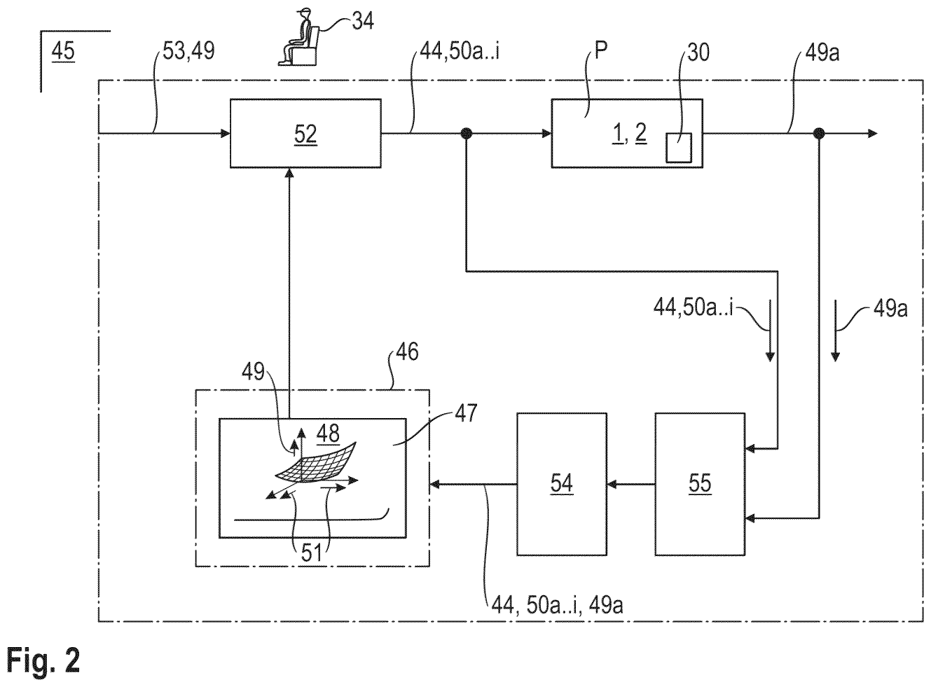

For a better understanding, general aspects of the driver assistance system 45 are described in further detail in FIG. 2. In an optimization step 52, the driver assistance system 45 automatically optimizes the work parameters 44, 50a . . . i of the agricultural work machine 1 designed as a combine harvester 2. The optimization of the work parameters 44, 55a . . . i may depend on a preselected harvesting process strategy 53 determining the optimization step 52, wherein the harvesting process strategy 53 may be specified by the operator 34, and in the simplest case, may define the quality parameters 49 to be achieved, such as maximum permissible grain losses or a purity of the grains 11 to be achieved, to name two quality parameters 49 only by way of example. The optimized work parameters 44, 55a . . . i automatically determined in the optimization step 52 may then be automatically transferred to the process P and automatically set in the particular working units 30 of the combine harvester 2, such as an optimized rotational speed 44 of a threshing drum assigned to the threshing units 7. The driver assistance system 45 may then automatically determine the quality parameters 49a resulting from an adjustment of the work parameters 44, 55a . . . i.

Both the optimized work parameters 44, 50a . . . i and the determined quality parameters 49a may be transmitted to the process optimization module 46 in a model adaptation step 54, wherein, depending upon the transmitted parameters 44, 50a . . . i, 49a, the process model 47 may then be adapted in a manner known per se if the saved process model 47 and the characteristic map 48 assigned thereto no longer describe the actual process P and therefore the dependencies between the particular quality parameter 49 and the particular control variables 51 with sufficient accuracy. As a rule, the model adaptation step 54 is preceded by a data preprocessing step 55.

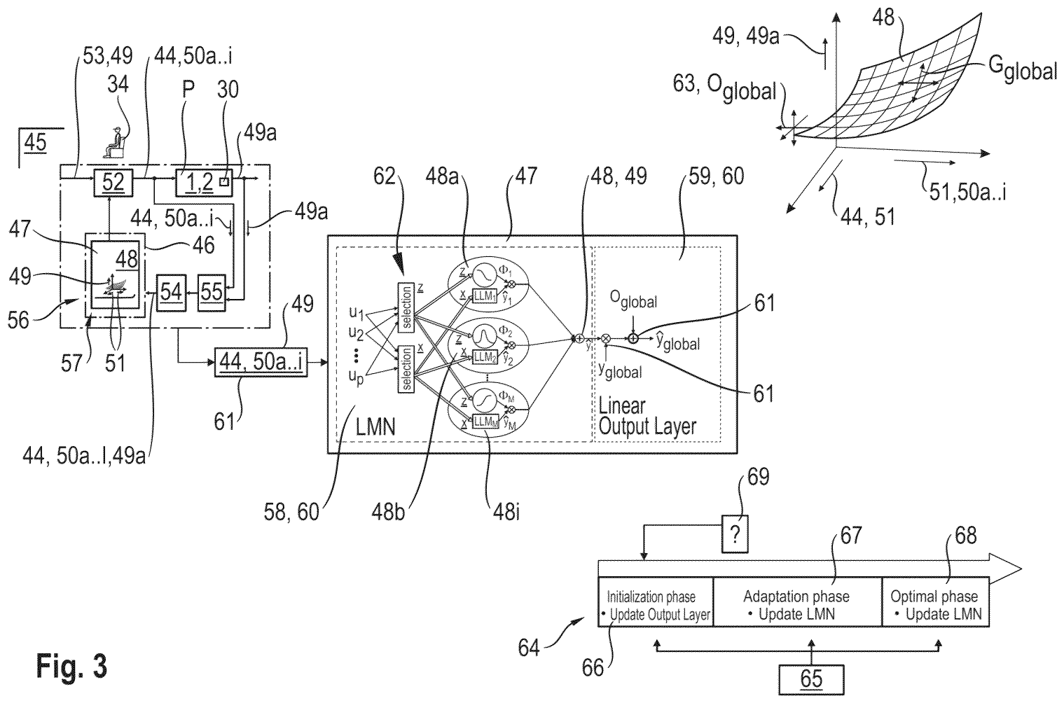

FIG. 3 shows details of the driver assistance system 45 with the process optimization module 46 assigned thereto, in which the process model 47 and the characteristic maps 48 assigned to the process model 47 are saved, wherein the process model 47 describes the relationship between work parameters 50a . . . i of a working unit 30, the manipulated variables 51, and the quality parameters 49 so that the optimization method 56 to be implemented by the driver assistance system 45 and to be explained in more detail is designed as a characteristic map control 57.

This general structure enables the driver assistance system 45 to automatically optimize and adjust the work parameters 44, 50a . . . i and the quality parameters 49, 49a of the agricultural work machine 1, wherein the optimization method 56 generates optimized work parameters 44, 50a . . . i as a control variable 51, and the driver assistance system 45 determines the quality parameters 49, 49a of the agricultural work machine 1 depending on the optimized work parameters 44, 50a . . . i.

In one or some embodiments, the process model 47 comprises a basic process model 58 and an affine output layer 59 assigned thereto. The basic process model 58 and the affine output layer 59 may form submodels 60 of the process model 47, with the basic process model 47 being configured and designed to map relationships between a large number of process parameters 61 in characteristic maps 48 for the generation of an optimized quality parameter (49, 49a), and the affine output layer (59) being designed and configured to define the particular quality parameters (49, 49a) depending on two process parameters (61).

As previously described, the work parameters 44 relating to the agricultural work machine 1 (such as the threshing drum rotational speed), the work parameters 50a . . . i, relating to the harvested material (such as the harvested material throughput), and the quality parameters 49, 49a (such as the grain losses) may be transferred to the process model 47 assigned to the process optimization module 46, whereby the transfer may be made to the basic process model 58 assigned to the process model 47. The basic process model 58 may comprise a neural network 62, such as a local model network. Specific characteristic maps 48a . . . i may be saved in the neural network 62 for a wide variety of quality parameters 49, 49a, through which optimized quality parameters 49, 49a and optimized characteristic maps 48a . . . i may be generated. In one or some embodiments, each quality parameter 49 may be assigned a characteristic map 48a . . . i. In one or some embodiments, the optimized operating points derived from the characteristic maps 48a . . . i may be transferred to the additional submodel 60, the affine output layer 59. The affine output layer 59 may define the quality parameter 49, 49a saved in the particular characteristic map 48 depending on at least two process parameters 61 (such as only two process parameters 61). In one or some embodiments, one of these process parameters 61 forms a multiplier Gglobal which may stretch or compress part or all of the entire characteristic map 48, while the other process parameter 61, Oglobal, may cause a shift 63 of the particular characteristic map 48a . . . i in space.

In one or some embodiments, the basic process model 58 and the affine output layer 59 are further designed such that they may be activated or executed independently of one another, with the activation or execution causing an adjustment of the characteristic maps 48 saved in the respective submodel 60. In one or some embodiments, the activation or execution of the basic process model 58 and the affine output layer 59 may be simultaneous (but independent). Alternatively, the activation or execution of the basic process model 58 and the affine output layer 59 may be at different times (while still independent).

By making the submodel 60 (affine output layer 59) dependent exclusively on two process parameters 61, slight or lower complexity may be achieved. In contrast to this, the basic process model 58 may be capable of causing significantly more complex changes to the process model 47 due to the higher number of parameters as well as the depicted dynamics. This difference in complexity and the potential for adapting both submodels 60 independently of each other may enable the entire process model 47 to be adapted specifically to the current data and process situation. If only a small amount of slightly excited data is available (e.g., at the beginning of the harvesting process on a new field), an adaptation of the basic process model may be at risk of so-called overfitting (e.g., the risk that machine learning methods are trained with known data but unknown data is taken into account in the application), which may result in either poor optimization results, or the particular model is unable to predict the unlearned data sufficiently well. Due to the small number of parameters of the affine output layer 59, there is no or less risk of overfitting from adjusting these process parameters 61. Instead, adjusting these process parameters 61 may allow the process model 47 to be adapted quickly and robustly with few and only partially excited process data. However, the effects on model behavior may be limited by the low complexity of the submodels 60 of the affine output layer 59. Locally different effects or changing dynamic behavior cannot be changed. Rather, in one or some embodiments, only the model output may be changed with the adaptation of the affine output layer 59 to correspond to the currently recorded data.

With the adaptation of the basic process model 58, however, it may be possible to respond specifically to subtle deviations between the current process model 47 and the behavior observed in the field. The adaptation of the basic process model 58 may make it possible to adapt both nonlinear and dynamic process behavior. With the model form of the basic process model 58, there may be a possibility of responding specifically to the prevailing process excitation in different local areas of the basic process model 58. This may mean that if there is good process excitation only at the current operating point of the combine harvester, this part of the basic process model 58 may be adapted. Other areas of the basic process model 58 may not or need not affected.

Against the backdrop that the quality of the adaptation and/or the optimization of the process model 47, its submodels 60, and the employed characteristic maps 48 may depend largely on the amount of available process information 65, explained in more detail below, the adaptation of process model 47 and its submodels 60 may comprise adaptation phases 64, whereby the activation of the particular or respective adaptation phase 64 may take place in a manner to be explained in more detail depending on the available process information 65. In this context, a first adaptation phase 64 may comprise an initialization phase 66, whereby in the initialization phase 66, the adaptation of the process model 47 may be limited to the adaptation of the submodel 60 of the affine output layer 59. A second adaptation phase 64 may be a so-called adaptation phase 67, whereby in the adaptation phase 67, the adaptation of the process model 47 is limited to the adaptation of the basic process model 58. A third adaptation phase 64 may comprise an optimal phase 68, whereby, in the optimal phase 68, the adaptation of the process model 47 is limited to the adaptation of the basic process model 58, and the parameterization of the basic process model 58 in the optimal phase 68 may differ from the parameterization of the basic process model 58 in the adaptation phase 67 in a manner described in more detail below, wherein the parameterization comprises the adaptation speed and the regularization strength.

By operating the process model 47 in the different adaptation phases 64, situation-dependent adaptation of the process model 47 may become possible. The recognition of the situation may be determined based on various sources. On the one hand, any one, any combination, or all of the adapted submodels 60, the characteristic maps 48 assigned to them, and the prediction error may be used as criteria to determine the quality level of the entire process model 47 and its submodels 60. Furthermore, available environmental parameters (e.g., any one, any combination, or all of crop type, crop type change, weather change, soil conditions, or cultivation differences with regard to crop type) may be used to specify the current harvest situation. With the information about the current situation, suitable parameterization of the model adaptation may then be performed. It is contemplated to switch between predefined parameter sets and to continuously and/or dynamically adjust the parameters based on the situation. In this way, it is possible overall for the driver assistance system to automatically switch between the respective adaptation phases 64 depending on the amount of available data points, the available environmental parameters, and the adaptation status (which may be determined by any one, any combination, or all of the data availability, the excitation of the process by the work parameters, the convergence behavior of the adaptation method, and the variance of the estimation of certain process parameters in the submodel of the process basic model).

In each of the respective adaptation phases 64, different adaptation algorithms and parameterizations of the adaptation of the process model 47 and its submodels 60 may be used. In the initialization phase 66, robust adaptation may not be possible due to the small amount of data. In order to nonetheless enable rapid adaptation of the entire process model 47, the adaptation of the affine output layer 59 may be used in the initialization phase 66. Upon reaching the adaptation phase 67, which may be characterized by the convergence of the parameters of the affine output layer 59, the driver assistance system may automatically switch the adaptation to the basic process model 58. The details of the process behavior may now be learned or disclosed by adapting the basic process model 58. Upon reaching the optimal phase 68 (characterized by a sufficiently accurate process model 47), the adaptation may remain with the parameters of the basic process model 58. The model error, which may now be expected to be lower (as opposed to other phases such as the adaptation phase 67), may result in only minor adjustments to the basic process model 58 (e.g., fewer adjustments to the basic process model than in the adaptation phase 67), and therefore ultimately to the process model 47 made by the adaptation.

With regard to the available process information 65, the driver assistance system 45 may start at the beginning of harvesting (e.g., beginning to perform the harvesting process) in the initialization phase 66 and may automatically switch to the adaptation phase 67 depending on the amount of available data points, the available environmental parameters, and the adaptation status (which may be determined by any one, any combination, or all of the data availability, the excitation of the process by the work parameters, the convergence behavior of the adaptation method, and the variance of the estimation of certain process parameters in the submodel of the basic process model). When the driver assistance system 45 determines that a quasi-stationary phase (e.g., a specific type of stochastic process phase where the system exhibits a form of stability over time, despite the presence of underlying dynamics that may cause fluctuations within the respective phase) of the basic process model 58 has been reached, the system may then automatically switch to the optimal phase 68. In one or some embodiments, only upon the detection of another large model error 69 (e.g., the driver assistance system 45 determines a weather change greater than a predetermined amount, a field change greater than a predetermined amount, a crop type change greater than a predetermined amount, etc.), is the model adaptation automatically returned or switched to the initialization phase 66 and the process may be iteratively executed again.

As previously described, the complex basic process model 58 may map a nonlinear, dynamic process behavior, whereas the submodel 60 of the affine output layer 59 may map a linear process behavior in such a way that the particular characteristic map 48 is stretched or compressed and/or shifted in space.

In a manner known per se, the quality parameters 49, 49a may comprise any one, any combination, or all of the “threshing loss,” the “broken grain fraction,” the “separation loss,” the “cleaning loss,” the “threshing unit load,” the “fuel consumption,” the “returns grain fraction,” and the “returns volume.”

The process parameters 61 may comprise, in a manner known per se, the work parameters 44, 50a . . . i of the agricultural work machine and/or environmental parameters and/or harvested material parameters.

Furthermore, the work parameters 44, 50a . . . i of the agricultural work machine may be the threshing drum rotational speed, the concave width, etc. in a manner known per se. In a manner also known per se, the work parameters 44, 50a . . . i of the agricultural work machine may also be the harvested material parameters of throughput, straw moisture, and grain moisture.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | | | |
|---|---|---|---|
| 1 | Agricultural work machine | 34 | Operator |
| 2 | Combine harvester | 35 | Bus system |
| 3 | Grain header | 36 | Sensor system |
| 4 | Inclined conveyor | 37 | Computing unit |
| 5 | Harvested material flow | 38 | Internal information |
| 6 | Threshing concave | 39 | External information |
| 7 | Threshing unit | 40 | Information |
| 8 | Deflection drum | 41 | Output signal |
| 9 | Separating rotor assembly | 42 | Display signal |
| 10 | Separating device | 43 | Working unit signal |
| 11 | Grains | 44 | Operating parameter |
| 12 | Returns pan | 45 | Driver assistance system |
| 13 | Feed pan | 46 | Process optimization mode |
| 14 | Screening level | 47 | Process model |
| 15 | Screening level | 48 | Performance map |
| 16 | Fan | 49.49a | Quality parameter |
| 17 | Cleaning device | 50a . . . i | Operating parameter |
| 18 | Grain flow | 51 | Manipulated variable |
| 19 | Elevator | 51 | Optimized manipulated variable |
| 20 | Grain tank | 52 | Optimization step |
| 21 | Funnel-shaped housing | 53 | Harvesting process strategy |
| 22 | Straw chopper | 54 | Model adaptation step |
| 23 | Shredding device | 55 | Data preprocessing step |
| 24 | Straw | 56 | Optimization method |
| 25 | Ground | 57 | Characteristic map control |
| 26 | Crop distribution device | 58 | Basic process model |
| 27 | Residual material flow | 59 | Affine output layer |
| 28 | Residual material flow | 60 | Submodel |
| 29 | Chaff spreader | 61 | Process parameters |
| 30 | Working unit | 62 | Neural network |
| 31 | Vehicle cabin | 63 | Shift |
| 32 | Display unit | 64 | Adaptation phase |
| 33 | Control and regulation device | 65 | Process information |
| 66 | Initialization phase | | |
| 67 | Adaptation phase | | |
| 68 | Optimal phase | | |
| 69 | Model error | | |
| 72 | Processor | | |
| 73 | Memory | | |
| 74 | Communication interface | | |
| Gglobal | Process parameters | | |
| Oglobal | Process parameters | | |

1. An agricultural work machine comprising
one or more working units; and
a driver assistance system configured to automatically optimize and adjust one or both of at least one work parameter or at least one quality parameter in order to generate, respectively, at least one optimized work parameter or at least one optimized quality parameter;
wherein the driver assistance system is assigned a process model comprising characteristic maps such that an optimization method implemented by the driver assistance system comprises a characteristic map control;
wherein the optimization method generates the at least one optimized work parameter as a control variable;
wherein the driver assistance system is configured to determine the at least one optimized quality parameter of the agricultural work machine depending on the at least one optimized work parameter;
wherein the process model comprises a basic process model and an affine output layer assigned thereto;
wherein the basic process model and the affine output layer form submodels of the process model;
wherein the basic process model is configured to map relationships between a plurality of process parameters in characteristic maps for generating the at least one optimized quality parameter;
wherein the affine output layer is configured to define a respective quality parameter depending on at least two process parameters; and
wherein the driver assistance system is configured to automatically control the one or more working units based on one or both of the at least one optimized work parameter or the at least one optimized quality parameter.

2. The agricultural work machine of claim 1, wherein the process base model and the affine output layer are executed independently of each other; and
wherein the driver assistance system, responsive to determining activation of a respective one of the process base model or the affine output layer, is configured to adjust the characteristic maps in a respective process base model or the affine output layer.

3. The agricultural work machine of claim 1, wherein the driver assistance system is automatically configured to select a respective phase, from a plurality of phases, depending on process information that is available; and
wherein the driver assistance system is configured to adapt at least a part of the process model dependent on the respective phase that is selected.

4. The agricultural work machine of claim 3, wherein the plurality of phases comprises a first phase configured as an initialization phase; and
wherein, in the initialization phase, the driver assistance system is configured to adapt the process model solely to adaptation of the affine output layer.

5. The agricultural work machine of claim 3, wherein the plurality of phases comprises a second phase configured as an adaptation phase after an initialization phase; and
wherein, in the adaptation phase, the driver assistance system is configured to adapt the process model solely to adaptation of the basic process model.

6. The agricultural work machine of claim 3, wherein the plurality of phases comprises a third phase configured as an optimal phase; and
wherein, in the optimal phase, the driver assistance system is configured to adapt the process model solely to adaptation of the basic process model different from the adaptation in a previous phase.

7. The agricultural work machine of claim 6, wherein the plurality of phases comprises a second phase configured as an adaptation phase after an initialization phase; and
wherein, in the optimal phase, the driver assistance system is configured to adapt the process model solely to the adaptation of the basic process model different from parameterization of the adaptation in the adaptation phase.

8. The agricultural work machine of claim 3, wherein the plurality of phases comprises a first phase configured as an initialization phase, a second phase configured as an adaptation phase after the initialization phase, and a third phase configured as an optimal phase after the second phase;
wherein, in the initialization phase, the driver assistance system is configured to adapt the process model solely to adaptation of the affine output layer;
wherein, in the adaptation phase, the driver assistance system is configured to adapt the process model solely to adaptation of the basic process model; and
wherein, in the optimal phase, the driver assistance system is configured to adapt the process model solely to the adaptation of the basic process model different from the adaptation in adaptation phase.

9. The agricultural work machine of claim 3, wherein the driver assistance system is configured to:
automatically determine one or more of an amount of available data points, available environmental data, or an adaptation state; and
automatically switch between respective phases, of the plurality of phases, based on the one or more of the amount of available data points, the available environmental data, or the adaptation state.

10. The agricultural work machine of claim 9, wherein the driver assistance system is configured to:
automatically determine an amount of available data points, available environmental data, and an adaptation state; and
automatically switch between respective phases, of the plurality of phases, based on the amount of available data points, the available environmental data, and the adaptation state.

11. The agricultural work machine of claim 9, wherein the driver assistance system is configured to:
start in an initialization phase at a start of harvesting;
responsive to analyzing an amount of available data points, available environmental parameters, or adaptation state, switch to an adaptation phase; and
responsive to automatically determining reaching a quasi-stationary phase of the process base model, switch to an optimal phase.

12. The agricultural work machine of claim 9, wherein, in an initialization phase, the driver assistance system is configured to adapt the process model solely to adaptation of the affine output layer;
wherein, in an adaptation phase, the driver assistance system is configured to adapt the process model solely to adaptation of the basic process model; and
wherein, in an optimal phase, the driver assistance system is configured to adapt the process model solely to the adaptation of the basic process model different from the adaptation in the adaptation phase.

13. The agricultural work machine of claim 12, wherein, responsive to detecting an error, the driver assistance system is configured to revert back to the initialization phase.

14. The agricultural work machine of claim 13, wherein the error comprises one of a weather change greater than a predetermined amount, a field change greater than a predetermined amount, or a crop type change greater than a predetermined amount.

15. The agricultural work machine of claim 1, wherein the basic process model maps a nonlinear, dynamic process behavior.

16. The agricultural work machine of claim 1, wherein the submodel of the affine output layer maps a linear process behavior in such a way that a respective characteristic map is one or more of: stretched or compressed; or shifted in space.

17. The agricultural work machine of claim 1, wherein the at least one quality parameter comprise one or more of threshing loss, broken grain fraction, separation loss, cleaning loss, threshing unit load, fuel consumption, returns grain fraction, or returns volume.

18. The agricultural work machine of claim 1, wherein at least one process parameter comprises one or more of work parameters of the agricultural work machine, environmental parameters, or harvested material parameters.

19. The agricultural work machine of claim 1, wherein the at least one work parameter of the agricultural work machine comprises one or both of threshing drum rotational speed or concave width.

20. The agricultural work machine of claim 1, wherein the at least one work parameter of the agricultural work machine comprises harvested material parameters of throughput, straw moisture, and grain moisture.
